(19) United States
(12) Patent Application Publication
(10) Pub. No.: US 2008/0000335 A1
(43) Pub. Date: Jan. 3, 2008

(54) Automatic Cutting Device Put on a Floor and a Support Device for Automatic Cutting Device Put on a Floor

(76) Inventor: Makoto Koshihata, Yamanashi (JP)

Correspondence Address: JORDAN AND HAMBURG LLP, 122 EAST 42ND STREET, SUITE 4000, NEW YORK, NY, 10168, US

(21) Appl. No.: 10/553,244

(22) PCT Filed: Aug. 17, 2005
(86) PCT No.: PCT/JP05/15025

§ 371 Date: Dec. 19, 2006

(51) Int. Cl. B26D 1/14

(52) U.S. Cl. 83/471; 83/651

(57) ABSTRACT

The automatic cutting device which is put on a floor includes a base which can support a cutting member; a supporting member for a cutting blade, attaching a back end portion thereof to a part adjacent one end portion of a center part of the base, capable of rotating a tip portion thereof in a vertical direction; a cutting device, driving rotatably by a motor provided at a vertical rotatable part of the supporting member, capable of cutting the cutting member supported by the base by the cutting blade; and the sloping means which can incline the base corresponding to a slope of the cutting member supported by the base. Therefore, only one person can put the cutting member on the base at a closely contact and can operate to cut the cutting member without the length and weight of the cutting member.

### FIELD OF THE INVENTION

The present invention relates to an automatic cutting device, including a radial arm saw device, which is put on a floor and a support device for the automatic cutting device which is put on a floor.

### BACKGROUND OF THE INVENTION

The conventional radial arm saw device which is put on a floor is positioned the cutting member on the base horizontally and carried out the slitting operation.

In this way, there is no problem to carry out the slitting operation when the cutting member is shortened, however, it is too hard to prepare to position the cutting member on the base horizontally by one person when the cutting member is long and heavy comparatively. Then it has to be carried out by more than two people. In addition, it cannot cut the cutting member vertically if it cannot support the cutting member well.

### SUMMARY OF THE INVENTION

Accordingly, it is an object of the present invention to provide a automatic cutting device which is put on a floor and a support device for the automatic cutting device which is put on a floor which can be carried out easily by oneself in a condition that the cutting member is attached firmly to the base without reference to the length and weight of the cutting member.

The present invention is understood to encompass embodiments which include all or only a portion of the above objects, features and advantages which, unless recited in claims defining the invention, are understood not to limit interpretation of such claims. The above, and other objects, features and advantages of the present invention will become apparent from the following description read in conjunction with the accompanying drawings, in which like reference numerals designate the same elements.

It is to be expressly understood, however, that the drawings are for the purpose of illustration and description only, and are not intended as a definition of the limits of the invention.

### BRIEF DESCRIPTION OF THE DRAWINGS

FIG. 1 is a front view showing a first embodiment of the present invention;

FIG. 2 is a side view showing a first embodiment of the present invention;

FIG. 3 is a plane view showing a first embodiment of the present invention;

FIG. 4 is an explanation view of a base showing a first embodiment of the present invention;

FIG. 5 is an explanation view of a sloping means showing a first embodiment of the present invention;

FIG. 6 is an explanation view showing the way in which a cutting member is attached fixedly by sandwiching in a first embodiment of the present invention;

FIG. 7 is an explanation view when in cutting showing a first embodiment of the present invention;

FIG. 8 is an explanation view showing the way in which it cut with an incline in a first embodiment of the present invention;

FIG. 9 is a plane view showing a second embodiment of the present invention;

FIG. 10 is a cross sectional view taken along the line 10-10 in FIG. 9;

FIG. 11 is a front view showing a third embodiment of the present invention;

FIG. 12 is a side view showing a third embodiment of the present invention;

FIG. 13 is an explanation view when in use showing a third embodiment of the present invention;

FIG. 14 is a front view showing a fourth embodiment of the present invention;

FIG. 15 is a bottom view showing a fourth embodiment of the present invention;

FIG. 16 is an explanation view of a sloping means showing a fourth embodiment of the present invention;

FIG. 17 is an explanation view when in use showing a fourth embodiment of the present invention;

FIG. 18 is a front view showing a fifth embodiment of the present invention;

FIG. 19 is a side view showing a fifth embodiment of the present invention;

FIG. 20 is an explanation view when in use showing a fifth embodiment of the present invention;

FIG. 21 is a front view showing a sixth embodiment of the present invention;

FIG. 22 is a side view showing a sixth embodiment of the present invention;

FIG. 23 is an explanation view when in use showing a sixth embodiment of the present invention;

FIG. 24 is a front view showing a seventh embodiment of the present invention;

FIG. 25 is a side view showing a seventh embodiment of the present invention; and

FIG. 26 is an explanation view when in use showing a seventh embodiment of the present invention.

### DETAILED DESCRIPTION OF THE PREFERRED EMBODIMENTS

Preferred embodiments of the present invention are described in more detail below referring to the accompanying drawings.

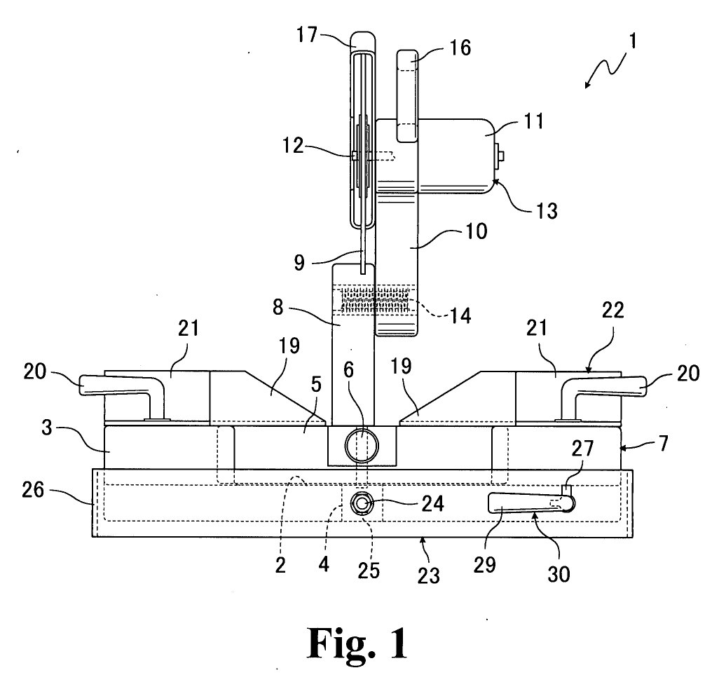

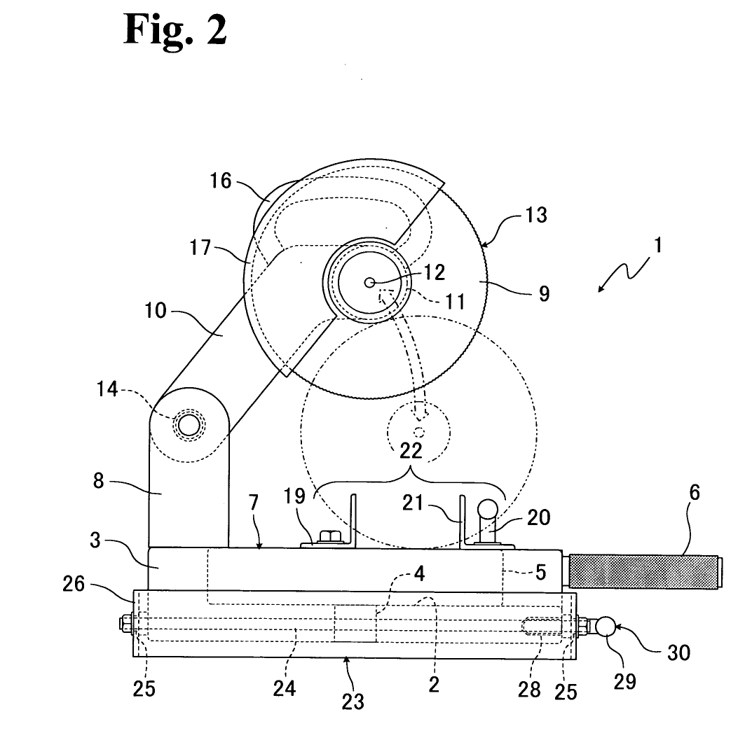

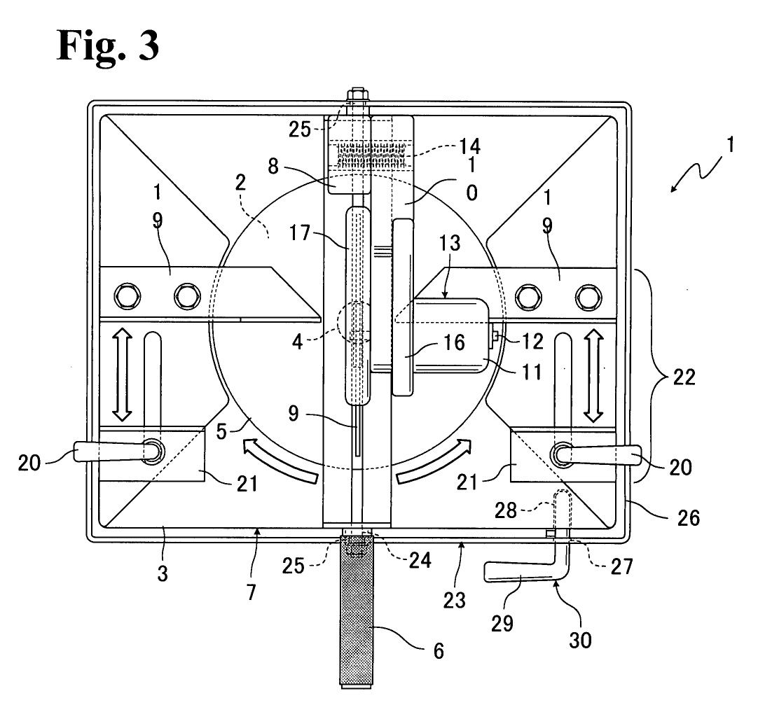

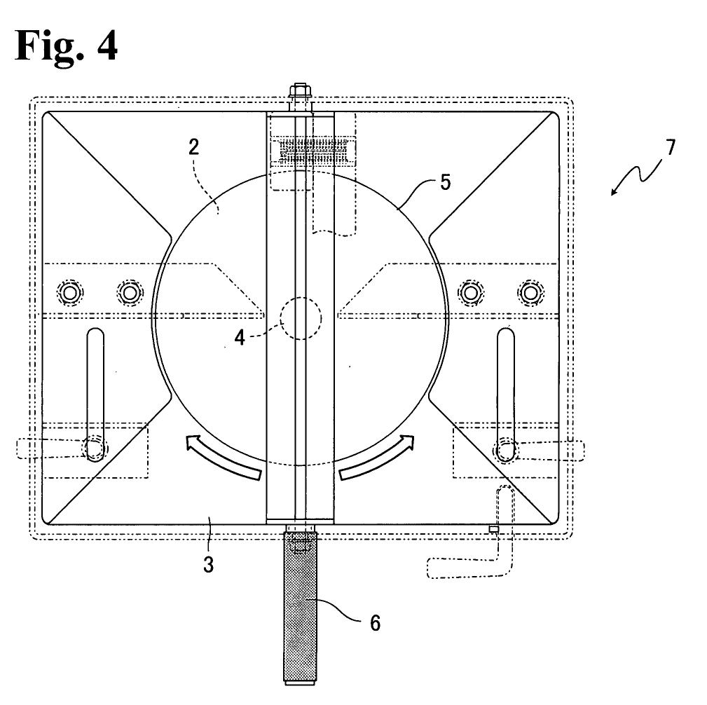

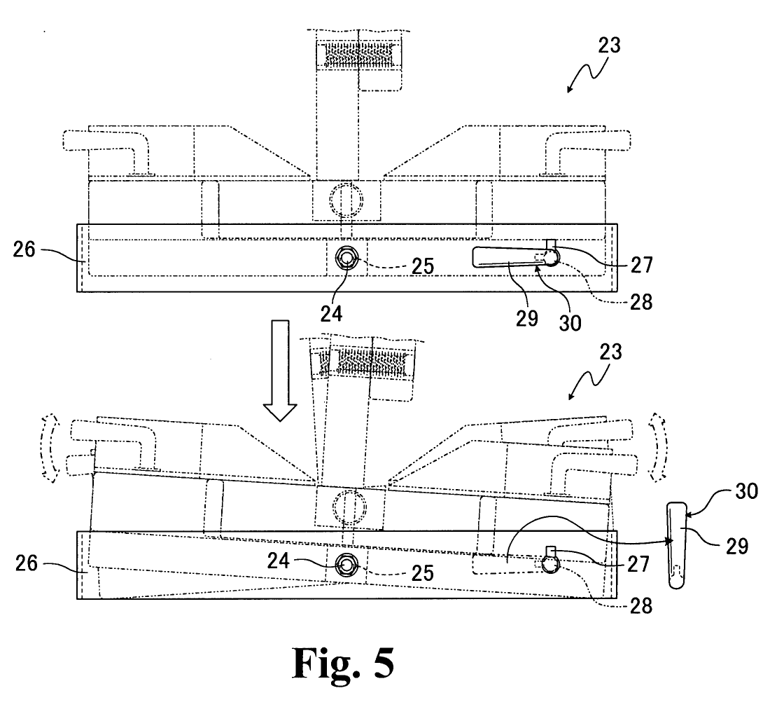

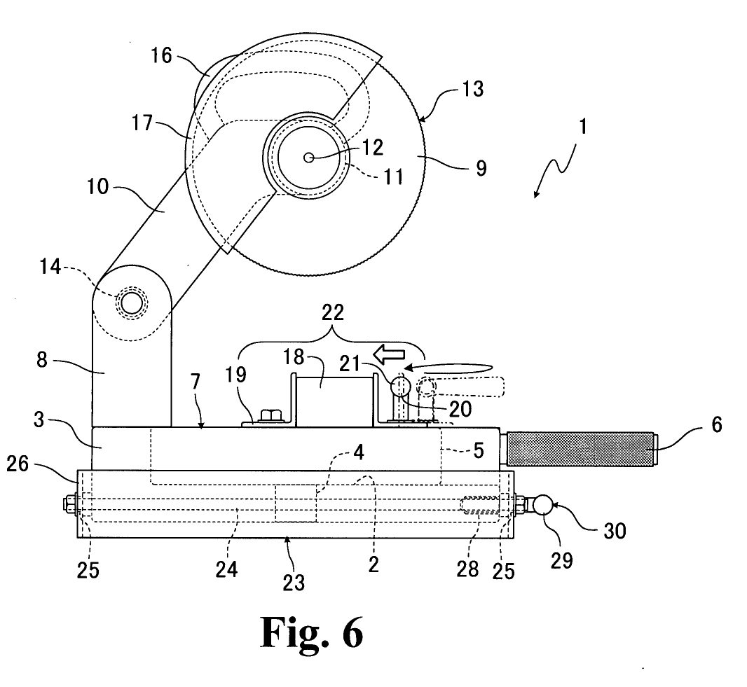

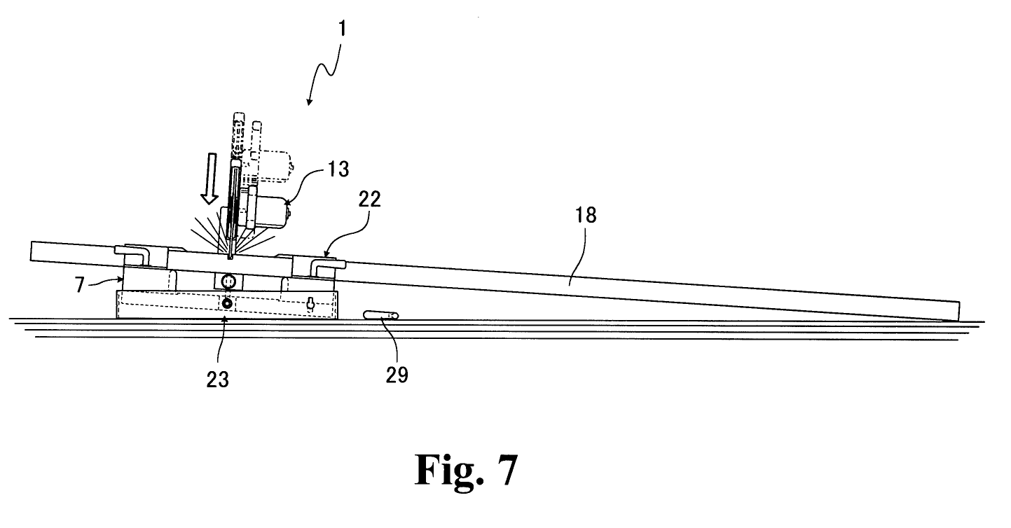

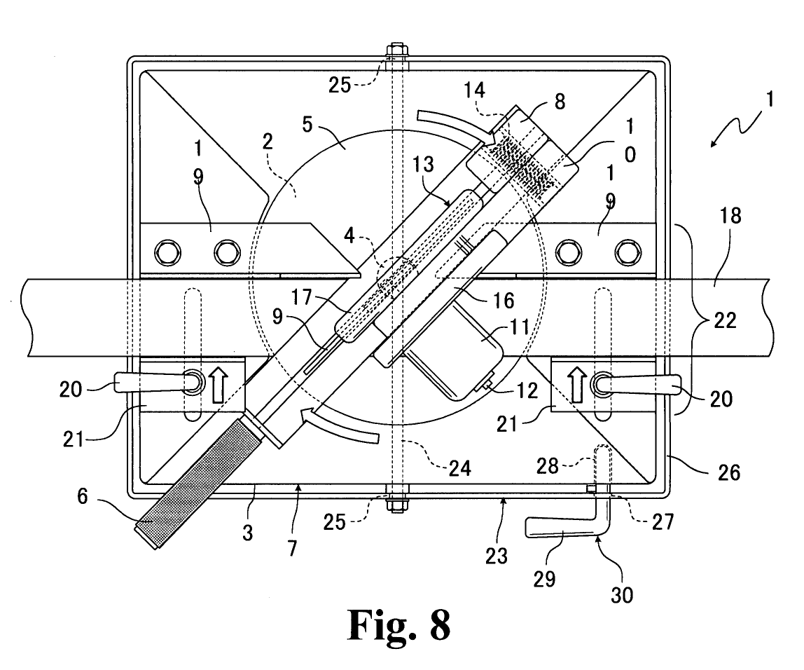

An understanding of the present invention may be best gained by reference FIGS. 1 to 8. Reference numeral 1 is an automatic cutting device which is put on a floor. The automatic cutting device 1 is comprised of a base 7 further including a base body 3 forming a concave part 2 at a center portion in an upper portion thereof, a rotatable base 5 having an upper surface which is supported pivotably and rotatably at near 90 degrees by a pivot pin 4 at the concave part 2 of the base body 3, positioning the upper surface thereof horizontally to the upper surface of the base body 3 and an operation lever 6 which is projected from the rotatable base 5 in an anterior direction, capable of rotating the rotatable base 5 at 45 degrees in a transverse direction; a supporting member 10 for a cutting blade, attaching rotatably to a supporting arm 8, capable of making a cutting blade 9 which is formed in the shape of a disc saw to position at a center portion of the rotation of the rotatable base 5, the supporting arm 8 which is attached fixedly to rear portion of the rotatable base 5 of the base 7 so as to project upward; a cutting device 13 including a motor 11 attached to the supporting member 10 for the cutting blade and the cutting blade 9 as the disc saw attached to a drive shaft of the motor 11; a spring 14 bias the supporting member 10 for the cutting blade upwardly every time; a handle 16 which is formed at a case 15 of the motor 11; a cover 17 which covers a part except for the under side of the cutting blade 9; a holding device 22 including a fixable holding piece 19 having a cutting member 18 which is fixed on the base body 3, the cutting member 18 being fixed at right angles to the cutting direction of the cutting blade 9 and a movable holding piece 21 capable of sliding on the base body 3 so as to attach fixedly by sandwiching the fixable holding piece 19 and cutting member 18, having a lock mechanism 20 which can fix at an optional position; and means for sloping the base 7 corresponding to the slope of the cutting member 18 which is attached fixedly by sandwiching the fixable holding piece 19 and movable holding piece 21 of the base 7.

The sloping means 23 further includes a shaft 24 provided the cutting part of the cutting blade 9 of the base body 3 of the base 7 at a part as a shaft core so as to project both ends outwards; a supporting frame 26 formed shaft holes 25, 25 which are inserted the both ends of the shaft 24, capable of making the right and left sides of the base 7 to rotate in a horizontal direction; and a base-locking device 30 including a guide hole 27 for a locking pin 29, forming at a part adjacent the end portion of the supporting frame 26, capable of locking so as to keep the horizontal state of the base 7, an insertion hole 28 for the locking pin 29, forming at the base body 3 and being associated with the guide hole 27 at a horizontal state pretty much and the locking pin 29 which is inserted in the guide hole 27 and insertion hole 28 and locked.

For the automatic cutting device 1 which is described, when the lengthy cutting member 18 is cut, the base-locking device 30 is released, and the cutting member 18 is positioned between the fixable holding piece 19 of the base 7 and movable holding piece 21 of the holding device 22. Then the cutting member 18 is pushed to the fixable holding piece 19 by the movable holding piece 21 and is attached fixedly by sandwiching by the locking mechanism 20.

Then, one end part of the lengthy cutting member 18 is positioned on the floor surface and becomes the slope surface. However, since the base 7 has the same incline to the incline of the cutting member 18 with a focus on the shaft 24 of the sloping means 23 by its weight of the cutting member 18 or pressing the cutting member 18 so as to contact the base body 3, the cutting member 18 can be fixed to the holding device 22 with ease operation.

After that, it makes the motor 11 of the cutting device 13 to drive and the cutting blade 9 to rotate. Also it makes the cutting blade supporting member 10 to move downward against the power of the spring 14 by the handle 16, and the cutting member 18 is cut by the cutting blade 9.

Then, the supporting member 10 attached the cutting blade 9 is provided to the rotatable base 5 which is attached rotatably to the base body 3 so that it can cut at a vertical state even though the base body 3 is positioned at a slope state which corresponds the incline of the cutting member 18.

In addition, the cutting member 18 is cut by rotating the rotatable base 5 in the right and left directions so it can cut with the predetermined incline at a vertical state in the length direction of the cutting member 18.

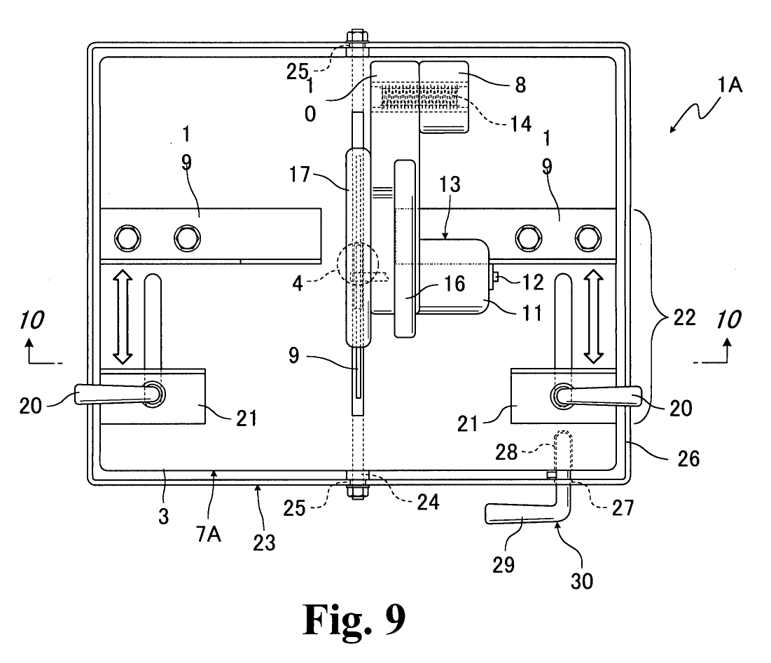

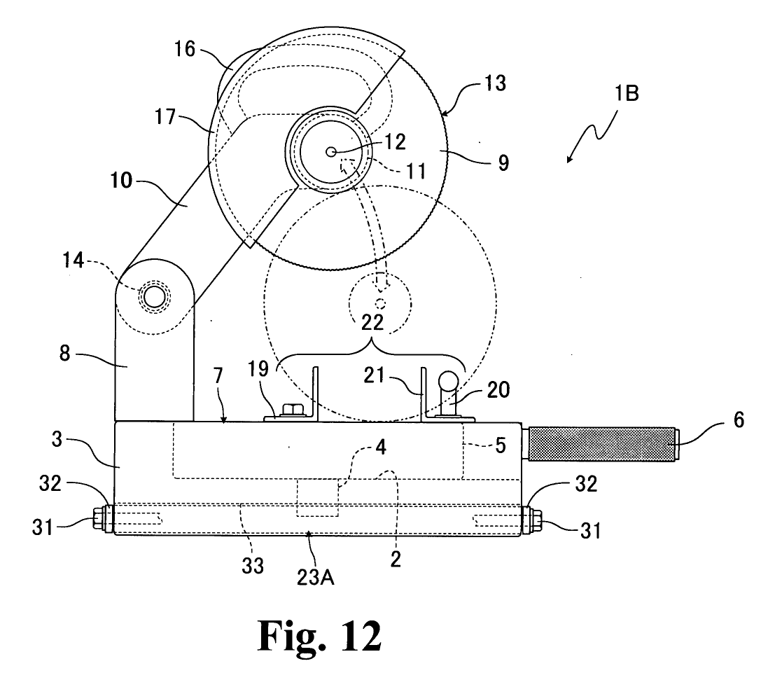

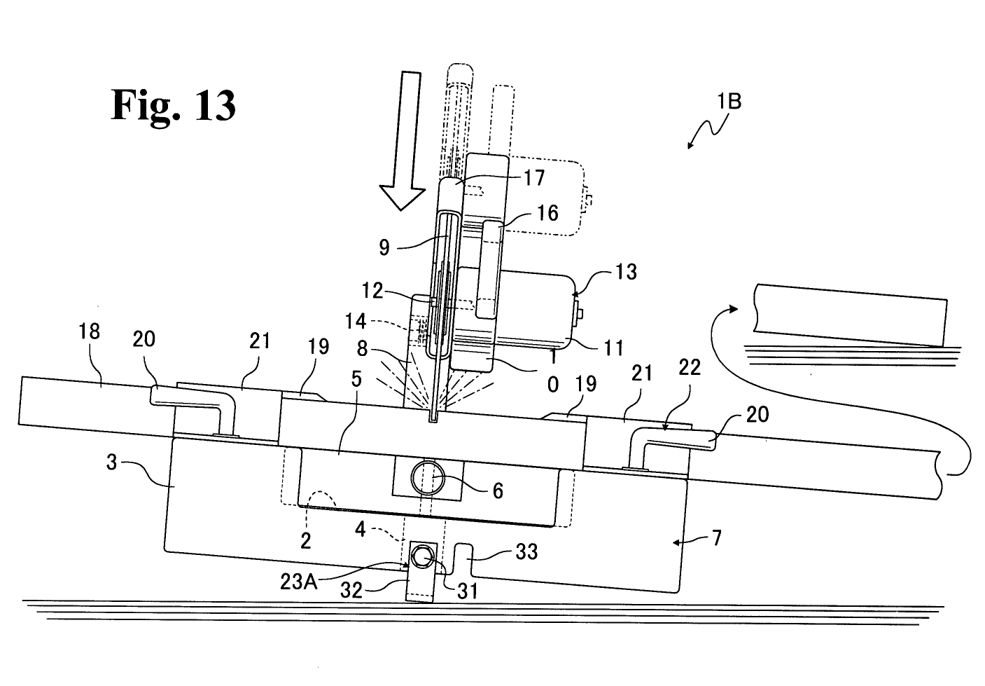

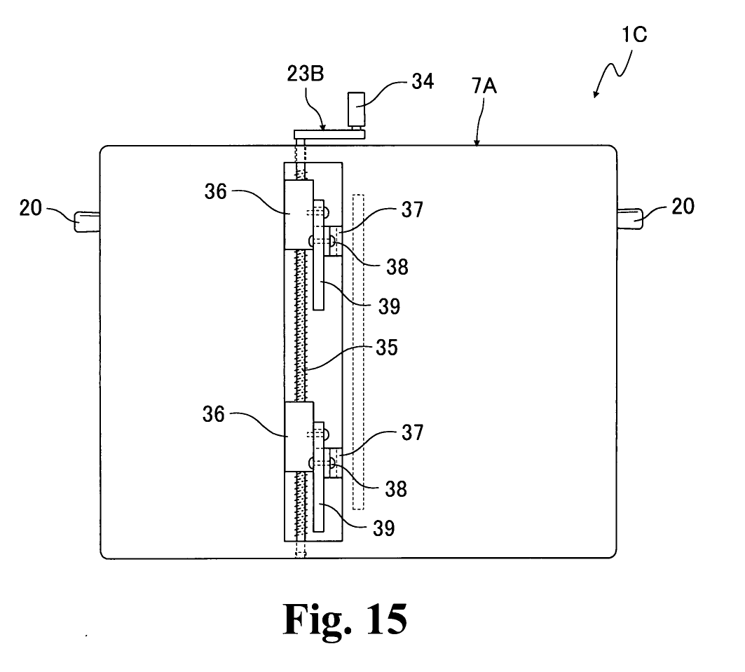

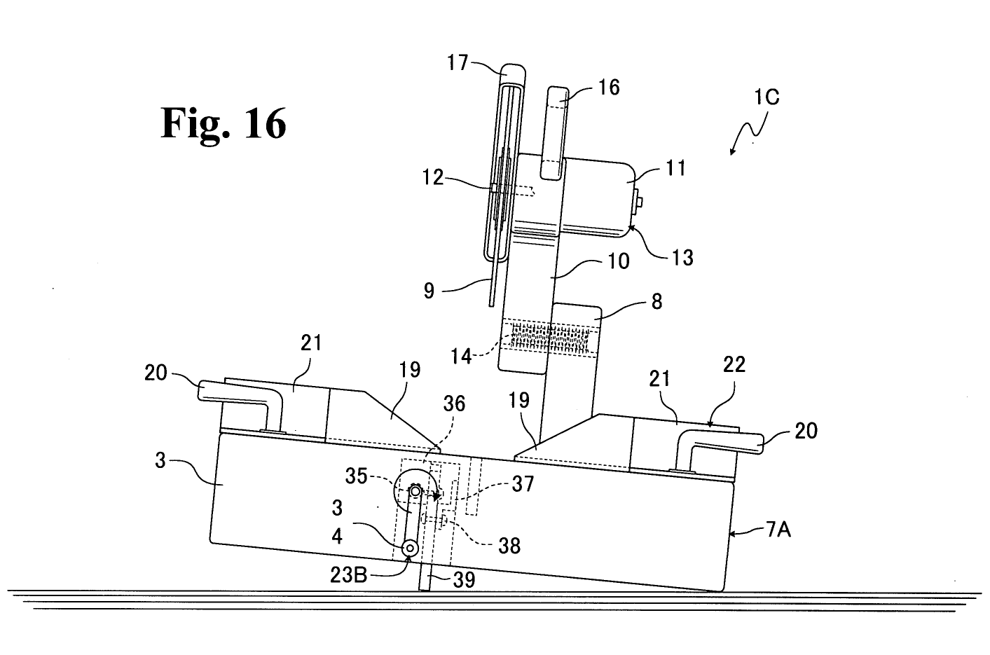

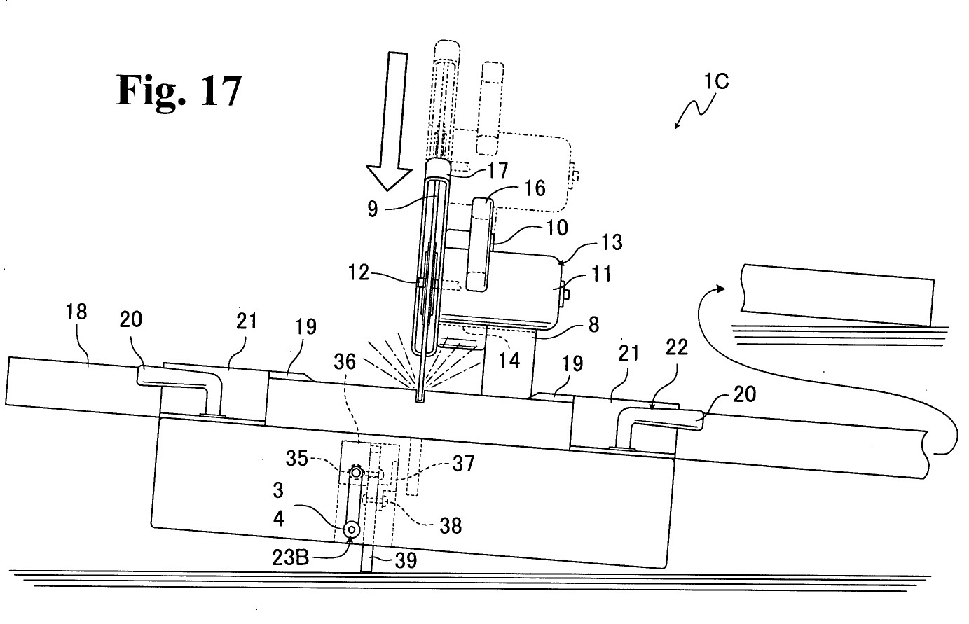

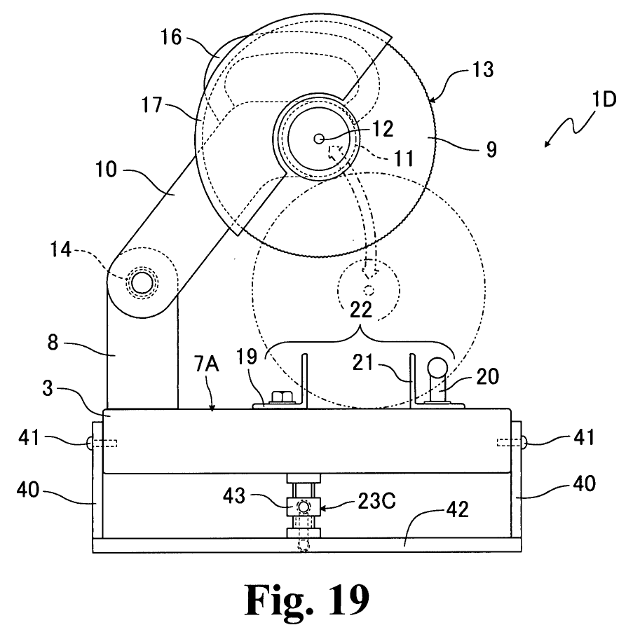

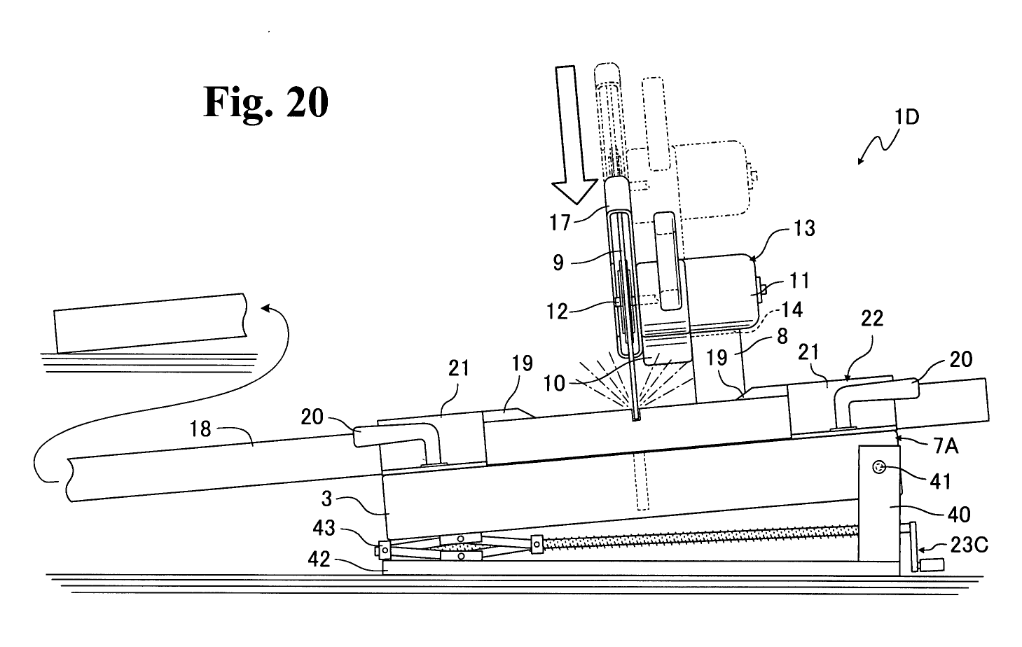

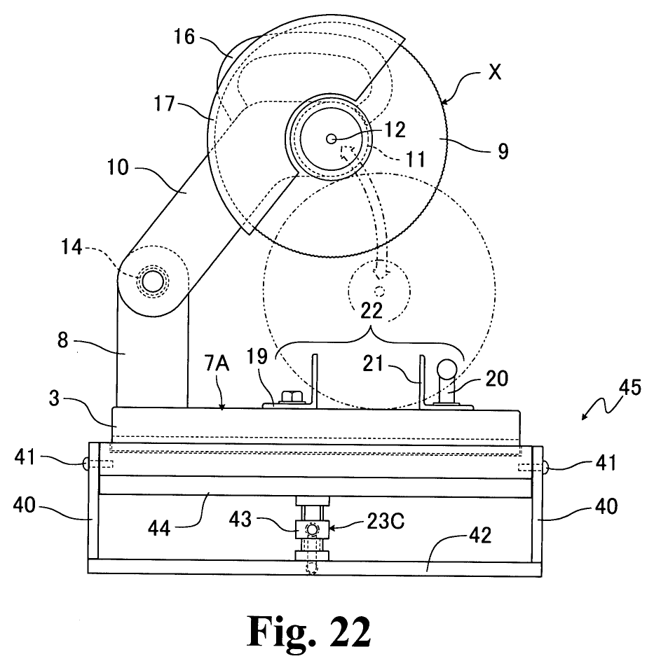

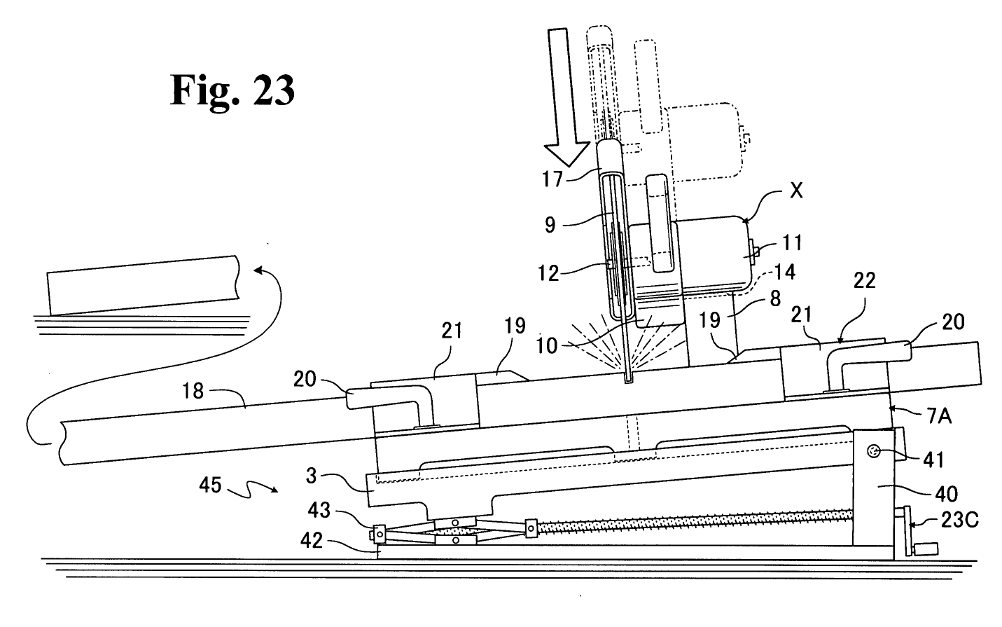

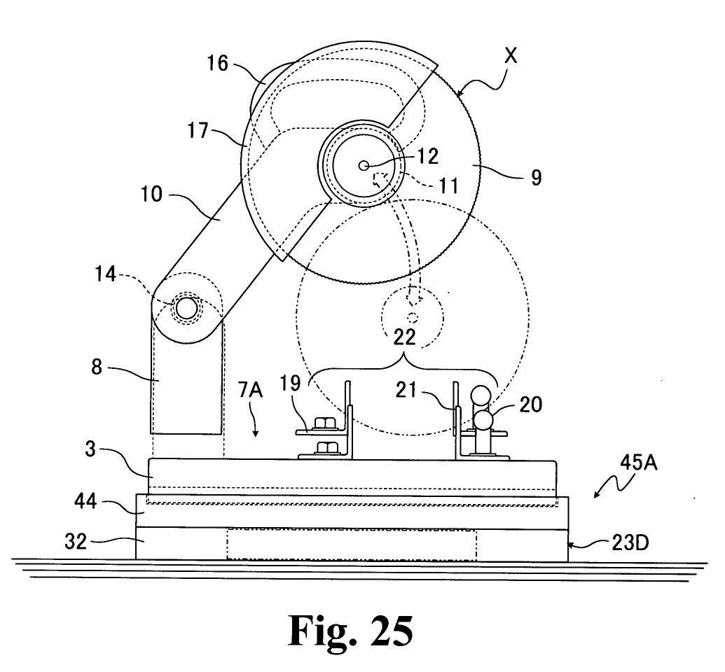

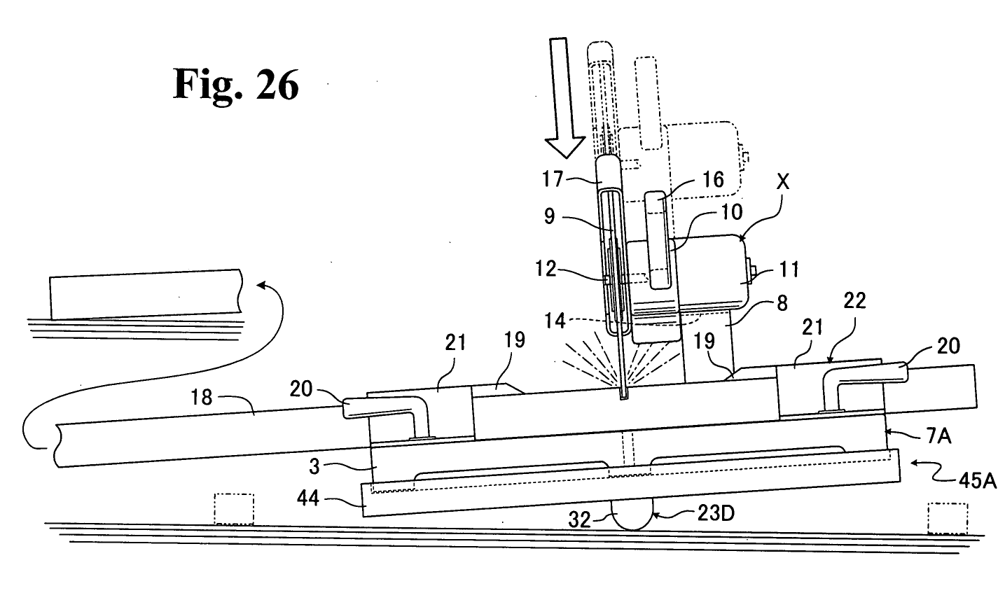

Other embodiments of the present invention will now be described referring to FIGS. 9 to 26. Through the drawings of the embodiments, like components are denoted by like numerals as of the first embodiment and will not be further explained in great detail.

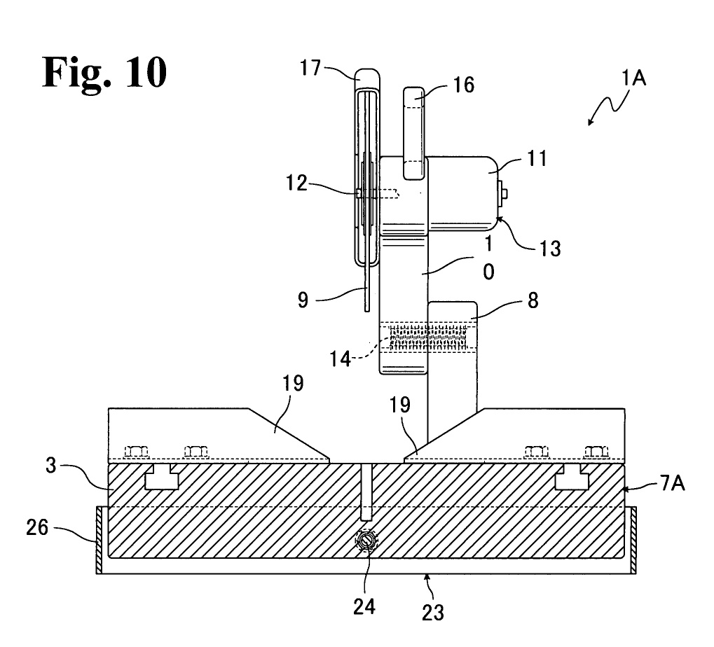

A second embodiment of the present invention is shown in FIGS. 9 and 10 and is distinguished from the first embodiment by the fact that the base 7 is replaced with another base 7A without the rotatable base. An automatic cutting device 1A with the base 7A, however it cannot cut slope surface, according to the second embodiment has similar advantages to that according to the first embodiment.

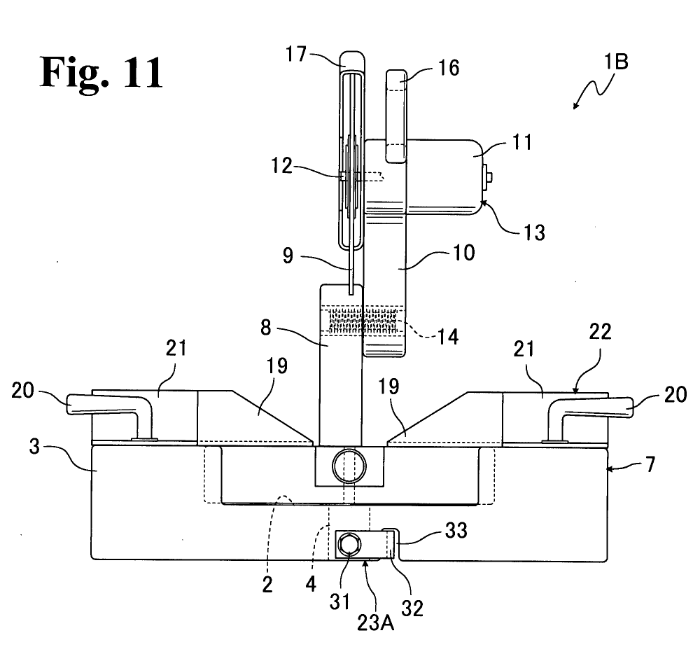

A third embodiment of the present invention is shown in FIGS. 11 to 13 and is distinguished from the first embodiment by the fact that the sloping means 23 is replaced with another sloping means 23A which further includes a supporting leg 32 provided to a center part at both sides of the base 7, rotating in the right and left directions by pivot pins 31, 31, forming in the shape of a C-letter and having a flat surface at bottom surface thereof and a concave part 33 which is put the supporting leg 32 therein of the bottom of the base 7 when it is not used. An automatic cutting device 1B with the sloping means 23A according to the third embodiment has similar advantages to that according to the first embodiment.

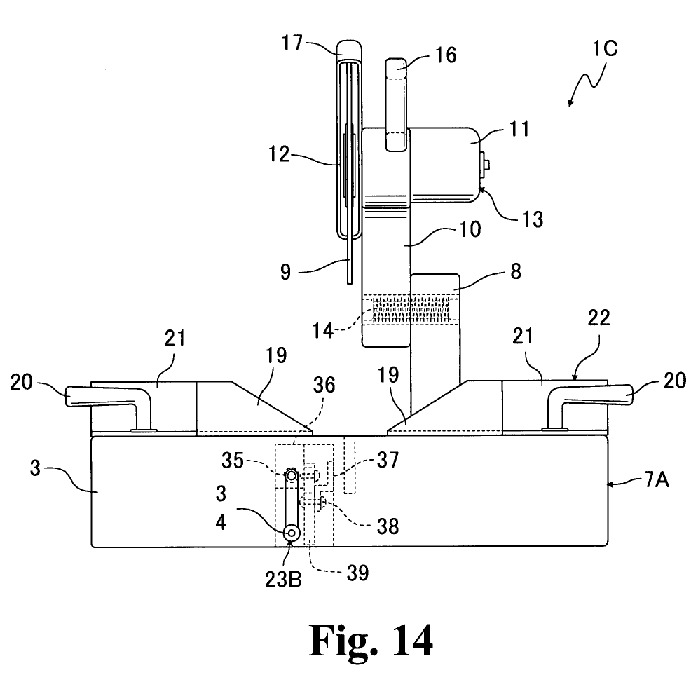

A fourth embodiment of the present invention is shown in FIGS. 14 to 17 and is distinguished from the second embodiment by the fact that the sloping means 23 is replaced with another sloping means 23B. The sloping means 23B includes a screw rod 35 attached to the center portion of the bottom surface of the base 7A so as to rotate by rotation of the handle 34; two operation rods 36, 36 threadably mounted on the screw rod 35, which is disposed at the anteroposterior part, moving in an anteroposterior direction which blocks the rotation at the bottom surface of the base 7A; and supporting legs 39, 39 supported pivotably at the bottom surface of the base 7A through mounting brackets 37, 37, having an upper part thereof being engaged with the operation rods 36, 36 a lower part thereof projecting downward compared to the bottom surface of the base 7A. An automatic cutting device 1C with the sloping means 23B according to the fourth embodiment has similar advantages to that according to the second embodiment.

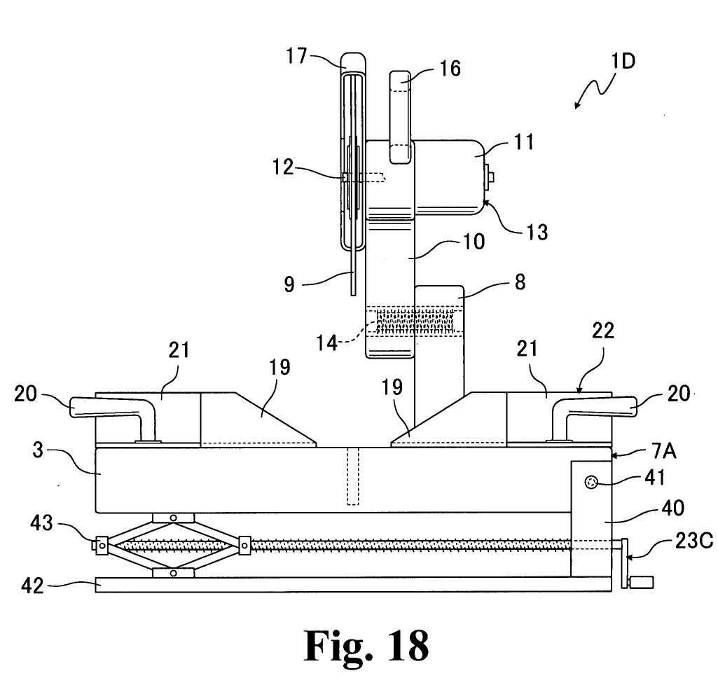

A fifth embodiment of the present invention is shown in FIGS. 18 to 20 and is distinguished from the second embodiment by the fact that the sloping means 23 is replaced with another sloping means 23C that further includes a supporting plate 42 having supporting pieces 40, 40 which project upward from one end thereof, supported pivotably by pivot pins 41, 41 at one end of the base 7A so as to rotate the right and left sides of the base 7A in the vertical direction; a height adjustment mechanism 43 having a hand-operated jack, capable of setting the slope of the base 7A to a part between the base 7A and supporting plate 42 positioned at a side of the anti-pivot pins 41, 41 of the supporting plate 42. An automatic cutting device 1D with the sloping means 23C according to the fifth embodiment has similar advantages to that according to the second embodiment.

In addition, the hand-operated jack as the height adjustment mechanism 43 is used and explained in this embodiment. In addition, it can be used any kind of mechanisms, which can adjust the height, such as cams, slider moving on the slope and the like.

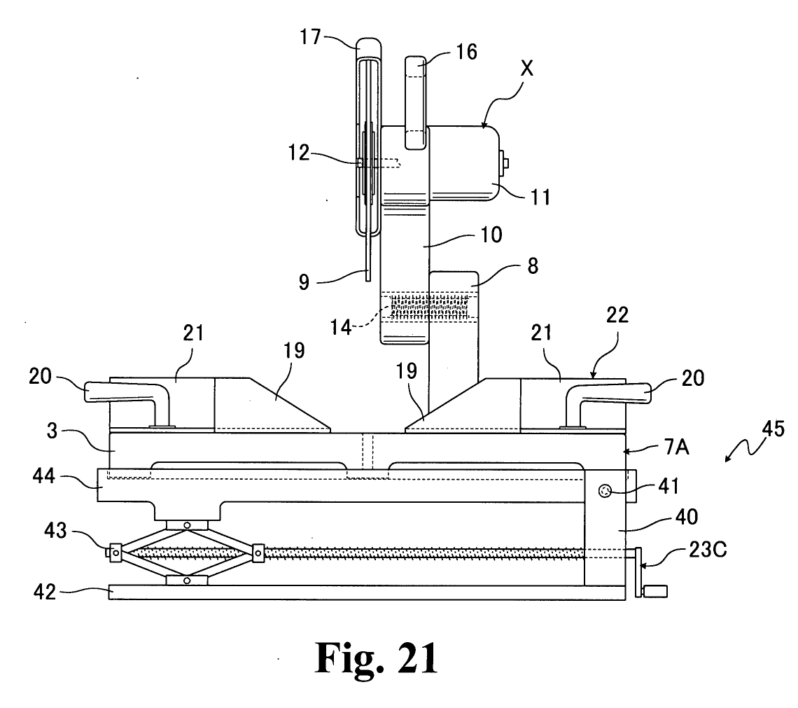

A sixth embodiment of the present invention is shown in FIGS. 21 to 23 and is distinguished from the fifth embodiment by the fact that a support device 45 for the automatic cutting device is used, capable of supporting the conventional automatic cutting device X at the supporting pieces 40, 40 of the supporting plate 42. The support device 45 for the automatic cutting device, supporting the automatic cutting device X according to the sixth embodiment has similar advantages.

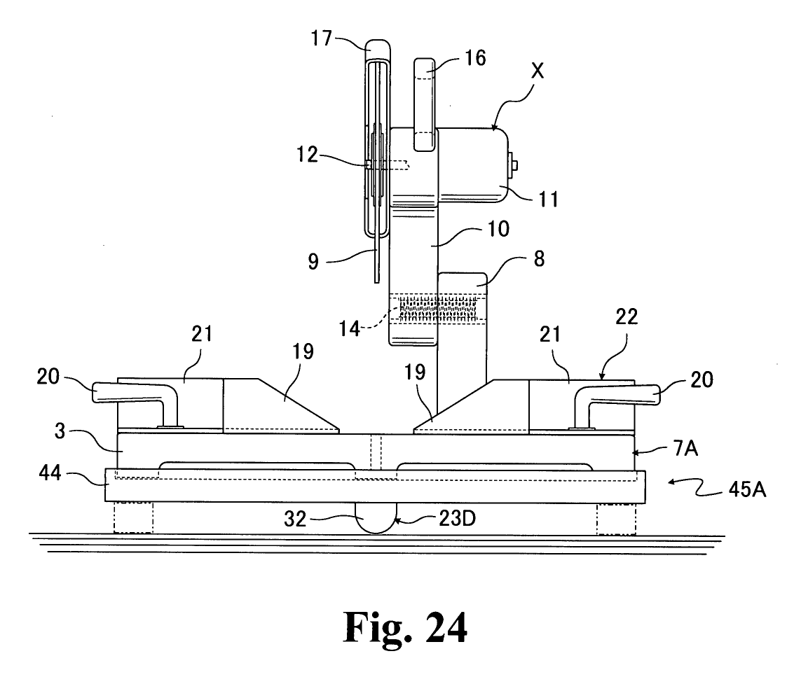

A seventh embodiment of the present invention is shown in FIGS. 24 to 26 and is distinguished from the sixth embodiment by the fact that the sloping means 23C is replaced with another sloping means 23D which further includes the supporting leg 32 provided at the center part of the support device 44, capable of rotating the right and left sides of the support device 44 in the vertical direction. A support device 45A for the automatic cutting device with the sloping means 23D according to the seventh embodiment has similar advantages to that according to the sixth embodiment.

In addition, the sloping means in the embodiments of the present invention is the device to rotate the right and left sides of the base in the vertical direction, and sloping means having the mechanism to rotate the right and left sides of the base in the vertical direction may be used.

Furthermore, the mechanism which can fix the leg member of the base on the floor on the condition that the base is inclined may be used.

Additionally, for each embodiment of the present invention, the holding device which fixes the cutting member is attached to the base, and the automatic cutting device without the holding device may be used on the condition that the device cuts the short and light cutting member especially.

The present invention is utilized in the industry to manufacture the automatic cutting device which is put on a floor and a support device for the automatic cutting device which is put on a floor.

As set forth above, the advantages of the invention are as follows:

(1) The automatic cutting device which is put on a floor includes a base which can support a cutting member; a supporting member for a cutting blade, attaching a back end portion thereof to a part adjacent one end portion of a center part of the base, capable of rotating a tip portion thereof in a vertical direction; a cutting device, driving rotatably by a motor provided at a vertical rotatable part of the supporting member, capable of cutting the cutting member supported by the base by the cutting blade; and the sloping means which can incline the base corresponding to a slope of the cutting member supported by the base. Therefore, the slope of the base can corresponds to the slope of the cutting member by positioning the cutting member to the base without the length and weight of the cutting member.

Accordingly, only one person can put the cutting member on the base at a closely contact and can operate to cut the cutting member in the vertical direction correctly.

(2) As discussed above, since all you need to do is provide the sloping means, it is easy to manufacture.

(3) As discussed above, even though the cutting member is long and has heavy weight, it makes the cutting member to be attached firmly to the base just to put the cutting member on the base at a positioned state.

Accordingly, the slitting operation can be carried out by oneself.

(4) Claims 2 to 9 have the same effect as the above-mentioned (1) to (3).

What is claimed is:

1. An automatic cutting device which is put on a floor comprising:
a base, capable of supporting a cutting member;
a supporting member for a cutting blade, attaching a back end portion thereof to a part adjacent one end portion of a center part of said base, capable of rotating a tip portion thereof in a vertical direction;
a cutting device, driving rotatably by a motor provided at a vertical rotatable part of said supporting member, capable of cutting said cutting member supported by said base by said cutting blade; and
means for sloping, capable of inclining said base corresponding to a slope of the cutting member supported by said base.

2. The automatic cutting device which is put on a floor according to claim 1, wherein said base further includes a holding device which fixes said cutting member by sandwiching.

3. The automatic cutting device which is put on a floor according to claim 1, wherein said supporting member for a cutting blade is attached rotatably to said base in a horizontal direction at a predetermined range, and said vertical rotatable part thereof being bias always by a spring upward.

4. The automatic cutting device which is put on a floor according to claim 1, wherein said sloping means is a supporting leg projects downward from a center portion of said base and lifts said base off said floor at a rotatable state in a vertical direction.

5. The automatic cutting device which is put on a floor according to claim 1, wherein said sloping means includes a supporting body, capable of supporting rotatably at right and left sides of said base in a vertical direction; and a height adjustment mechanism provided between said base and said supporting body, capable of setting said slope of said base according to need.

6. A support device for an automatic cutting device which is put on a floor comprising:
a supporting device, capable of supporting a base of said automatic cutting device which is put on a floor; and
means for sloping, said sloping means attached to said support device to rotate said base of said automatic cutting device in right and left directions.

7. The support device for an automatic cutting device which is put on a floor, said sloping means is a supporting leg projects downward from a center portion of said base and lifts said base off said floor at a rotatable state in a vertical direction.

8. The support device for an automatic cutting device which is put on a floor according to claim 6, wherein said sloping means includes a supporting plate, capable of supporting rotatably at right and left sides of said base in a vertical direction; and a height adjustment mechanism provided between said base and said supporting plate, capable of setting said slope of said base according to need.
